(19) United States
(12) Patent Application Publication
(10) Pub. No.: US 2004/0079627 A1
(43) Pub. Date: Apr. 29, 2004

(54) Electrical switch

(76) Inventors: Chieh-Rung Huang, Tu-Chen (TW); Fang-Jwu Liao, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/315,563

(22) Filed: Dec. 10, 2002

(30) Foreign Application Priority Data
Oct. 25, 2002 (TW) 91217042

(51) Int. Cl. H01H 5/18

(52) U.S. Cl. 200/406

(57) ABSTRACT

An electrical switch (100) includes an insulative housing (4) having four stationary contacts (5) retained therein, a movable contact plate (3), an actuator (2), and a top cover (1). The movable contact plate is made of a conductive material and has four electrically conductive arms (34) bending slightly downwardly therefrom. The movable contact plate is positioned in the insulative housing and the actuator is slidably positioned within the housing above the contact plate. The top cover attaches to a top of the housing, securely retaining the contact plate and the actuator within the housing. When the actuator is pressed inward into the housing, it forces the contact plate to move downwardly and the conductive arms electrically connect to the stationary contacts.

### CROSS-REFERENCE TO RELATED APPLICATION

The present application is related to a commonly assigned U.S. patent application, entitled “METAL DOME TACT SWITCH”, invented by Masao Okita and Fang-Jun Liao.

### BACKGROUND OF THE INVENTION

1. Field of the Invention

The present invention relates to an electrical switch, and particularly to an electrical switch requiring a light force for actuation and requiring reduced space.

2. Description of Prior Art

Referring to U.S. Pat. No. 4,588,877, a thin type push-button switch having a momentary operation is disclosed. The push-button switch comprises a movable contact piece 24, which is integrally formed of a resilient metal sheet and includes an inversion portion 24b and arms 24a, 24a′ formed in a manner to hold the inversion portion therebetween. The inversion portion is formed with a movable contact portion 24d having tongues 24c. A case 21 includes a groove 21d, which holds one of the arms in engagement therewith, and stationary contacts 22, 23, which are fixed within the case. A slider 25 includes a push button portion 25a and a groove 25c, which holds the other arm in engagement therewith. The slider is slidable with respect to the case. When the push button portion is depressed, the inversion portion of the movable contact piece is inverted to electrically connect the movable contact portion and stationary contacts. When the depressing force is released, the inversion portion is restored by the resiliency of the movable contact piece, to disconnect the movable contact portion and the stationary contacts.

Although the electrical switch described in the above prior art has a smaller size and a reduced number of components, the direction of the pushing force is perpendicular to the direction of movement of the movable contact piece. A large operating force is needed and the movable contact portion undergoes a large deflection, which is adverse to the longevity of the switch. After long-term use, the switch will be disabled.

Hence, an improved electrical switch is desired to overcome the disadvantages of the prior art.

### BRIEF SUMMARY OF THE INVENTION

A main object of the present invention is to provide an electrical switch occupying a small space, which requires a light force for operation, and which has a high reliability.

An electrical switch in accordance with the present invention comprises an insulative housing having four stationary contacts retained therein, a movable contact plate, an actuator, and a top cover. The contact plate has a peripheral portion, a depressing portion, and a connecting portion connecting the peripheral portion and the depressing portion. Four electrically conductive arms are formed on the connecting portion and bend slightly downwardly. The peripheral portion is positioned on lower steps of the insulative housing and the actuator is slidably positioned on higher steps within the housing above the contact plate. The top cover attaches to a top of the housing, securely retaining the contact plate and the actuator within the housing. The conductive arms are normally spaced vertically from the stationary contacts. When the actuator is pressed inwardly into the housing, it forces the contact plate to move downward and the conductive arms electrically connect to the stationary contacts.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an exploded perspective view of an electrical switch in accordance with the present invention;

FIG. 2 is a reverse angle view of FIG. 1;

FIG. 3 is an assembled view of FIG. 1;

FIG. 4 is a cross-sectional view taken along line 4-4 of FIG. 3; and

FIG. 5 is a view similar to FIG. 4, but showing the movable contact plate of FIG. 4 in a depressed state.

### DETAILED DESCRIPTION OF THE INVENTION

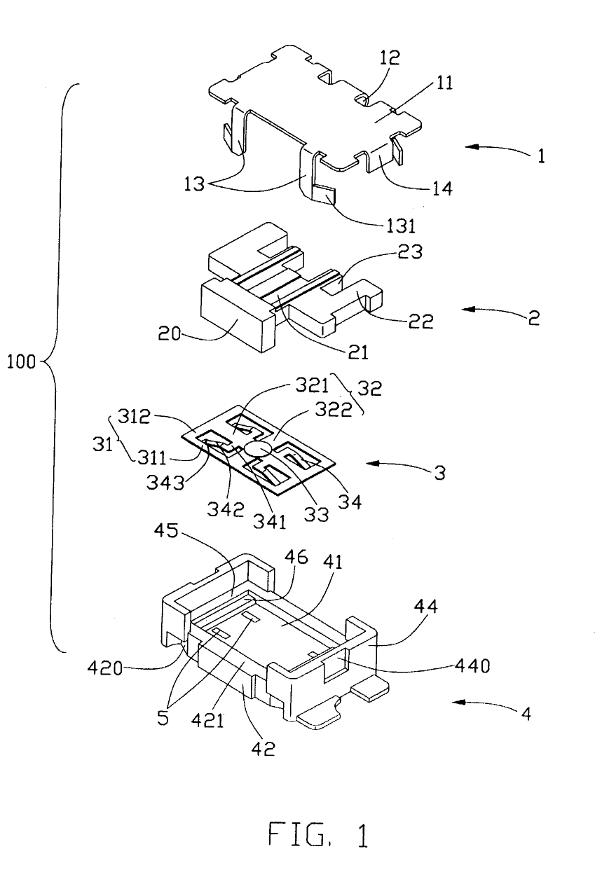

Referring to FIG. 1, an electrical switch 100 in accordance with a preferred embodiment of the present invention comprises a top cover 1, an actuator 2, a movable contact plate 3, and an insulative housing 4 with a plurality of stationary contacts 5 retained therein.

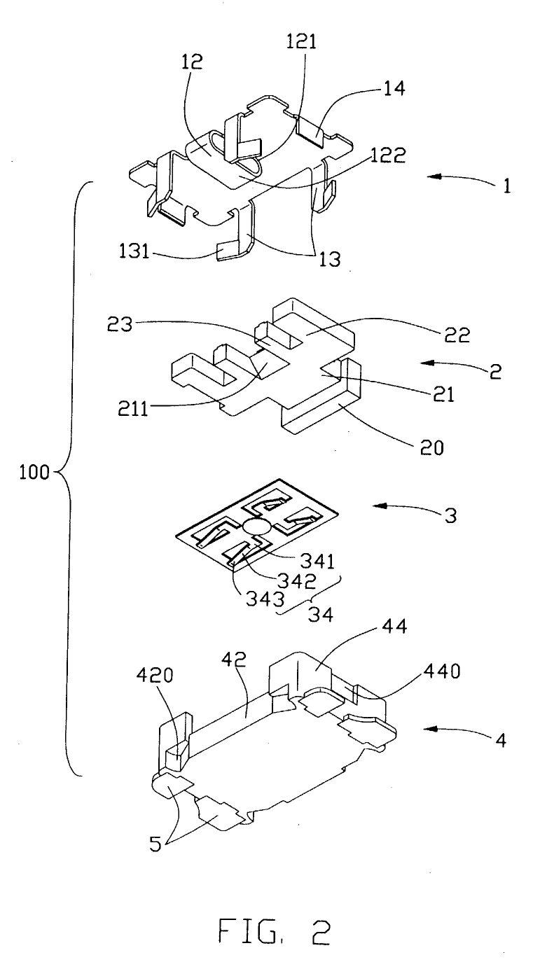

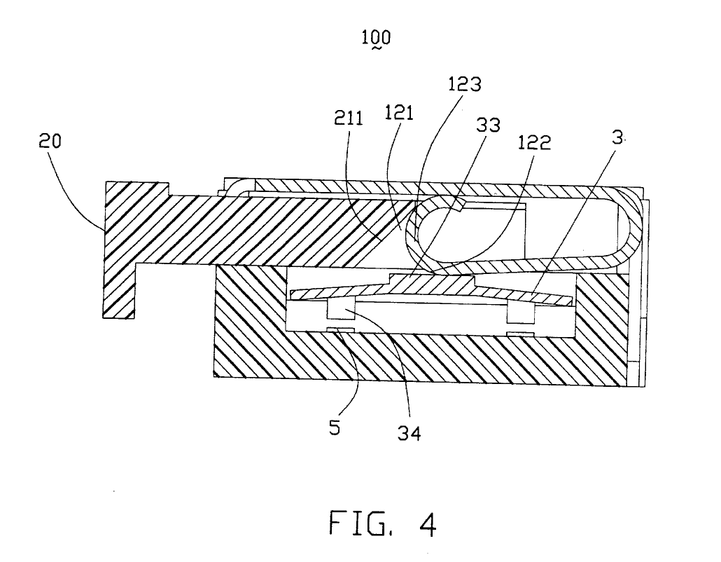

Referring to FIGS. 1 and 2, the top cover 1 defines a rectangular plate 11. The rectangular plate 11 has a front edge (not labeled), a rear edge (not labeled) and a pair of side edges (not labeled). A lever 12 extends from the rear edge of the plate 11 and bends in a curved shape under the plate 11. Referring also to FIG. 4, a contacting portion 121 proximal to the plate 11 and a depressing portion 122 away from the plate 11 are defined adjacent to a curved end 123 of the lever 12. Four tangs 13 extend downwardly from the front and rear edges and two tabs 14 extend downwardly from the two side edges. Each tang 13 extending from a same edge of the rectangular plate 11 is spaced from the other a predetermined distance. Each tang 13 has a lateral extended portion 131 extending from one end thereof.

The actuator 2 has a neck portion 21, an operating portion 20 formed at a front end of the neck portion 21, and a pair of outer fingers 22 and inner fingers 23 extending horizontally from a wide rear end of the neck portion 21. The outer fingers 22 are longer than the inner fingers 23. A ramp 211 is defined on an underside of and terminates at a rear edge of the neck portion 21, centered between the two inner fingers 23.

The movable contact plate 3 is integrally formed from a piece of conductive metal sheet. The movable contact plate 3 has a peripheral portion 31, a connecting portion 32, a depressing portion 33 and a plurality of conductive arms 34. The peripheral portion 31 has two parallel longitudinal edge portions 311 and two parallel lateral edge portions 312. The connecting portion 32 has a longitudinal connecting portion 321 and a lateral connecting portion 322 respectively spaced evenly from and parallel to corresponding edge portions 311, 312. The longitudinal connecting portion 321 and the lateral connecting portion 322 meet at the depressing portion 33. Four conductive arms 34 are symmetrically formed on and project from the longitudinal connecting portion 321. Each arm 34 has an inner end 341 perpendicularly projecting from the longitudinal connecting portion 321, and a bending portion 342 perpendicularly projecting from a distal end of the inner end 341 and extending downwardly at an angle. A contact portion 343 is formed at a lower end of each bending portion 342.

The four contacts 5 are partially embedded in the housing 4 by insert molding. The housing 4 has a bottom wall 41, through which the contacts 5 project, and a peripheral wall 42 projecting upwardly from and enclosing a periphery of the bottom wall 41. The peripheral wall 42 has an upper surface 421. Two U-shaped upper walls 44 extend upwardly from opposite ends of the peripheral wall 42, defining a front entrance (not labeled) and a rear entrance (not labeled) between opposing edges of the two upper walls 44. A cavity (not labeled) is defined within the peripheral and upper walls 42, 44 and above the bottom wall 41. A pair of higher steps 45 is formed by the upper surface 421 adjacent the upper walls 44. A pair of lower steps 46 are formed adjacent the corresponding higher steps 45. Four shallow portions 420 are defined in outward sides of the peripheral wall 42 for engagement with the lateral extended portions 131 of the tangs 13 of the top cover 1. Two recesses 440 are defined in outward sides of the U-shaped upper walls 44 for engagement with the tabs 14 of the top cover 1.

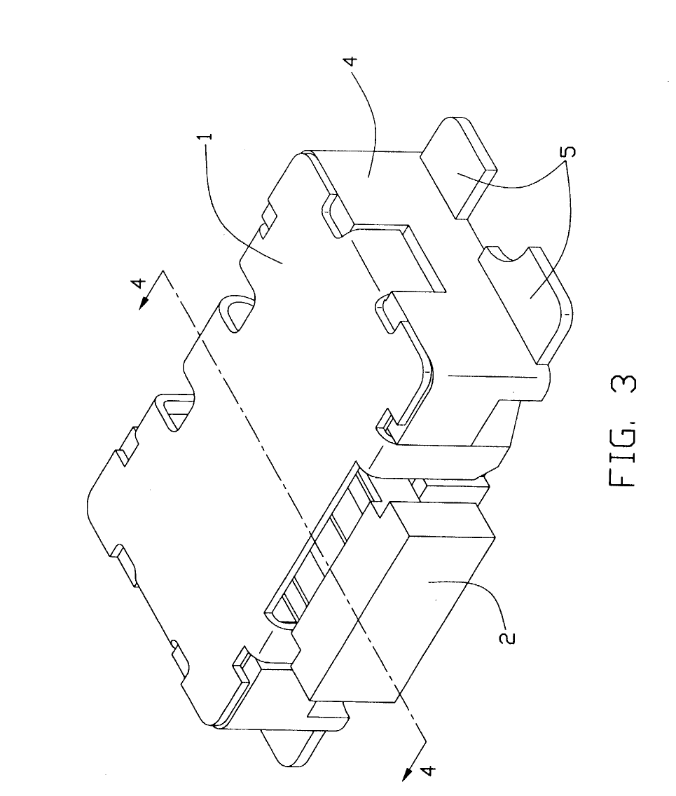

Refering to FIGS. 1, 2, 3, 4 and 5, in assembly, the movable contact plate 3 is positioned on the lower steps 46 of the housing 4 with each of the conductive arms 34 vertically separated from a corresponding contact 5. The actuator 2 is assembled in the cavity of the housing 4, with the operating portion 20 being positioned outward of the front entrance of the housing 4, the neck portion 21 being disposed on the upper surface 421 of the peripheral wall 42, and the outer fingers 22 being disposed on the higher steps 45 of the housing 4. The top cover 1 is assembled onto the housing 4 by engaging the lateral extended portions 131 of the tangs 13 within the shallow portions 420 of the peripheral wall 42, and engaging the tabs 14 thereof with the recesses 440 of the upper walls 44, while the lever 12 of the top cover 1 is received between the two inner fingers 23 of the actuator 2 with the upper contacting portion 121 of the lever 12 abutting against the ramp 211 of the actuator 2, and the lower depressing portion 122 of the lever 12 abutting against a top surface of the depressing portion 33 of the movable contact plate 3.

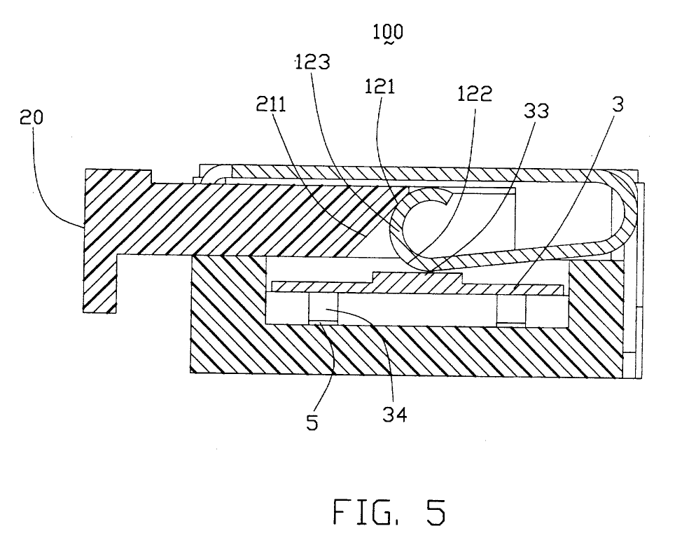

Also referring to FIGS. 4 and 5, in operation, the operating portion 20 is pressed horizontally by a user. The ramp 211 of the actuator moves rearwardly into the housing 4, driving the lever 12 of the top cover 1 downwardly, thereby forcing the lower depressing portion 122 of the lever 12 to press against the depressing portion 33 of the movable contact plate 3. The movable contact plate 3 in turn moves downwardly, so that each conductive arm 34 substantially simultaneously contacts a corresponding stationary contact 5, electrically connecting the contacts 5 to one another. A reverse operation occurs when the operating portion 20 of the actuator 2 is released, with the four contacts 5 recovering their electrical disconnection status.

The electrical switch 100 thus is small in size and simple in operation. It can be operated using less operating force than the prior art switch, and since the contact plate deflects less dramatically than the contact piece of the prior art, the switch of the present invention can have a longer life, and thus greater reliability.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the fill extent indicated by the broad general meaning of the terms in which the appended claims are expressed.

What is claimed is:

1. An electrical switch comprising:
an insulative housing having a plurality of stationary contacts retained therein; and
a movable contact plate made of a conductive material and having a holding portion, a depressing portion, a connecting portion connecting the holding portion to the depressing portion, and a plurality of electrically conductive arms formed on the connecting portion;
whereby, when the depressing portion is pressed downwardly, the contact plate moves downward and the conductive arms electrically connect to the stationary contacts, simultaneously electrically connecting the plurality of stationary contacts to one another.

2. The electrical switch as described in claim 1, wherein the holding portion is a frame-like structure having two parallel longitudinal edge portions and two parallel lateral edge portions.

3. The electrical switch as described in claim 1, wherein the connecting portion has a longitudinal connecting portion and a lateral connecting portion intersecting one another.

4. The electrical switch as described in claim 3, wherein the depressing portion is formed at an intersection of the longitudinal and lateral connecting portions.

5. The electrical switch as described in claim 1, wherein each conductive arm has an inner end perpendicularly projecting from the connecting portion, a bending portion perpendicularly projecting from the inner end and extending downwardly at an angle, and a contacting portion formed at an end of the bending portion.

6. The electrical switch as described in claim 5, wherein each contacting portion extends horizontally and is vertically spaced from a corresponding stationary contact when the contact plate is not in a downward position.

7. An electrical switch comprising:
an insulative housing;
a plurality of stationary contacts; and
a contact plate having a depressing portion and a plurality of conductive arms positioned over and spaced from the plurality of stationary contacts;
whereby, when the depressing portion is pressed downward, the contact plate moves downward and the conductive arms move into electrical contact with the plurality of stationary contacts.

8. An electrical switch comprising:
an insulative housing with therein a plurality of stationary contacts spaced from one another;
a vertically deflectable metallic contact plate positioned above said stationary contacts, said contact plate including a main body with a plurality of deflectable contacts extending downwardly therefrom toward but spaced from the corresponding stationary contacts, respectively, when said contact plate is not deflected, and
an actuator moveable relative to the housing and adapted to engage the main body of said contact plate to have said contact plate move up and down, wherein
the main body and the deflectable contacts of the contact plate experience different deflections when said contact plate is in a deflection manner, under a condition that the main body engages the actuator while the deflectable contacts engage the corresponding stationary contacts, respectively.
